(19) United States
(12) Patent Application Publication
(10) Pub. No.: US 2025/0323359 A1
(43) Pub. Date: Oct. 16, 2025

(54) SECONDARY BATTERY

(71) Applicant: Samsung SDI Co., Ltd., Yongin-si (KR)

(72) Inventors: Dae Kyu Kim, Yongin-si (KR); Jong Jun Park, Yongin-si (KR)

(73) Assignee: Samsung SDI Co., Ltd., Yongin-si (KR)

(21) Appl. No.: 19/011,205

(22) Filed: Jan. 6, 2025

(30) Foreign Application Priority Data
Apr. 12, 2024 (KR) 10-2024-0049194

(51) Int. Cl. H01M 50/169; H01M 50/107; H01M 50/141

(52) U.S. Cl. CPC H01M 50/169; H01M 50/107; H01M 50/141

(57) ABSTRACT

The present disclosure relates to a secondary battery. The secondary battery comprises: an electrode assembly; and a case accommodating the electrode assembly, wherein the case comprises an upper case having a terminal and a lower case adjacent to the upper case, and wherein the upper case and the lower case together comprise a bonded portion for bonding the upper case and the lower case to each other.

### CROSS-REFERENCE TO RELATED APPLICATIONS

This present application claims priority to and the benefit under 35 U.S.C. § 119(a)-(d) of Korean Patent Application No. 10-2024-0049194, filed on Apr. 12, 2024, in the Korean Intellectual Property Office, the entire disclosure of which is incorporated herein by reference.

### FIELD

The present disclosure relates to a secondary battery.

### BACKGROUND

Unlike a primary battery that cannot be charged, a secondary battery is a rechargeable and dischargeable battery. Low-capacity secondary batteries may be used for various portable small-sized electronic devices, such as a smartphone, a feature phone, a notebook computer, a digital camera, or a camcorder, and high-capacity secondary batteries are widely used as a power source for motor drives, such as those in hybrid vehicles or electric vehicles.

The above information disclosed in this Background section is for enhancement of understanding of the background of the present disclosure, and therefore, it may contain information that does not constitute related (or prior) art.

### SUMMARY

The present disclosure relates to a secondary battery capable of reducing parts and simplifying the manufacturing process.

These and other aspects and features of the present disclosure will be described in or will be apparent from the following description of embodiments of the present disclosure.

To solve the above technical problem, an exemplary secondary battery according to an embodiment of the present disclosure, for solving the technical problems, may include: an electrode assembly; and a case accommodating the electrode assembly, wherein the case comprises an upper case having a terminal and a lower case adjacent to the upper case, and wherein the upper case and the lower case together a bonded portion for bonding the upper case and the lower case to each other.

The lengths of the upper case and the lower case may be the same.

A length of the upper case may be larger than a length of the lower case.

A length of the upper case may be smaller than a length of the lower case.

The bonded portion of the upper case and the lower case may comprise protrusions, the upper case comprising at least one of the protrusions and the lower case comprising at least another of the protrusions, and the upper case and the lower case may be bonded and coupled to each other by engaging the protrusions with each other.

One or more of the protrusions of the upper case and the lower case may be coated with a waterproof member.

A welding area may be formed at a portion where the protrusions of the upper case and the lower case are coupled to each other.

A cross-section of each of the protrusions of the upper case and the lower case may have a rectangular shape.

A cross section of each of the protrusions of the upper case and the lower case may have a rectangular shape and in which one side of each of the protrusions has a diagonal line, and the protrusions of the upper case and the lower case may be coupled so that the diagonal lines thereof contact each other.

The bonded portion of the upper case and the lower case may comprise screw threads, the upper case and the lower case each comprising at least one of the screw threads.

The upper case and the lower case may be coupled to each other by screw coupling by the screw threads.

At least one of the screw threads of the upper case and the lower case may be coated with a waterproof member.

The bonded portion of the upper case and the lower case may include a welding area.

A welded portion that is welded in contact with the top end of the electrode assembly may be formed on an upper side of the upper case.

The welded portion may be formed to be concavely recessed toward an inside of the upper case.

The welded portion may be welded and coupled to the electrode assembly from an outside of the upper case.

The electrode assembly may be coupled to the upper case through resistance welding.

The lower case may be coupled to the electrode assembly by welding from an outside of the lower case.

A film layer and an adhesive layer for attaching the film layer to the electrode assembly may be included, and the secondary battery may further comprise a finishing tape that at least partially surrounds the electrode assembly.

The bonded portion may comprise a welding area, and a heating cover layer formed on the back of the welding area may be included.

The heating cover layer may be formed between the case and the finishing tape.

The heating cover layer may have a width in a vertical direction based on a welding contact point, which is a center point of the welding area.

The heating cover layer may be formed to have a width within a range of 5 mm above a welding contact point which is at a center point of the welding contact area and 5 mm below the welding contact point, wherein the width of the heating cover layer is in the lengthwise direction of the electrode assembly.

A width of the heating cover layer may correspond to the size of a welding bead in the welding area.

A difference in a continuous use temperature between the finishing tape and the heating cover layer may be 100 degrees (° C.) or more.

The bonded portion of the upper case and the lower case may include at least one of a welding, a screw coupling, or a fitting.

The upper case may include a circular upper side portion and an upper lateral side portion extending downward from an edge of the upper side portion, the lower case may include a circular lower side portion and a lower lateral side portion extending upward from an edge of the lower side portion, and the bonded portion may be provided between the upper lateral side portion and the lower lateral side portion.

### BRIEF DESCRIPTION OF DRAWINGS

The following drawings attached to this specification illustrate embodiments of the present disclosure, and further describe aspects and features of the present disclosure together with the detailed description of the present disclosure. Thus, the present disclosure should not be construed as being limited to the drawings:

FIG. 1 is a cross-sectional view of a secondary battery according to an embodiment of the present disclosure.

FIG. 2 is a cross-sectional view showing a state in which an upper case is assembled to an electrode assembly of the secondary battery according to an embodiment of the present disclosure.

FIG. 3 is a cross-sectional view showing a state in which both upper and lower cases are assembled to the electrode assembly of the secondary battery according to an embodiment of the present disclosure.

FIG. 4 is a cross-sectional view of a secondary battery according to another embodiment of the present disclosure.

FIG. 5 is a cross-sectional view of a secondary battery according to still another embodiment of the present disclosure.

FIGS. 6A to 6C show a structure of a coupled portion of an upper case and a lower case in a secondary battery according to an embodiment of the present disclosure.

FIGS. 7A to 7C show a structure of a bonded portion of an upper case and a lower case in a secondary battery according to another embodiment of the present disclosure.

FIGS. 8A and 8B show a structure of a coupled portion of an upper case and a lower case in a secondary battery according to still another embodiment of the present disclosure.

FIG. 9 is a cross-sectional view of a secondary battery according to various embodiments of the present disclosure.

FIG. 10 is an enlarged cross-sectional view of a welding area shown in FIG. 9.

### DETAILED DESCRIPTION

Hereinafter, the present disclosure will be described in detail. Prior to giving the following detailed description of the present disclosure, it should be noted that the terms and words used in the specification and the claims should not be construed as being limited to ordinary meanings or dictionary definitions but should be construed in a sense and concept consistent with the technical idea of the present disclosure, on the basis that the inventor can properly define the concept of a term to describe the disclosure in the best way possible. Therefore, the embodiments described in the specification and the configurations described in the drawings are only the most preferred embodiments of the present disclosure, and do not represent all of the technical ideas of the present disclosure. It is to be understood that there may be various equivalents and variations in place of them at the time of filing the present application.

In addition, as used herein, the terms “comprise or include” and/or “comprising or including,” when used in this specification, specify the presence of stated features, numbers, steps, operations, elements, and/or components, but do not preclude the presence or addition of one or more other features, numbers, steps, operations, elements, components, and/or groups thereof. In addition, when describing embodiments of the present disclosure, “can” and “may” may include “one or more embodiments of the present disclosure.”

In addition, for a better understanding of the invention, The attached drawings are not drawn to scale and the dimensions of some components may be exaggerated. In addition, the same reference numbers may be assigned to the same components in different embodiments.

A reference to two objects in comparison being the same means that they are substantially the same. Thus, the wording “substantially the same” may include cases where the same is considered to be a low level in the related art, for example, a deviation within 5%. In addition, when any of parameters is referred to as being uniform in a given region, it may mean that the parameter is uniform from an average perspective.

It will be understood that, although the terms “first,” “second,” “third,” etc., may be used herein to describe various elements, components, regions, layers and/or sections, these elements, components, regions, layers and/or sections should not be limited by these terms. These terms are used to distinguish one element, component, region, layer or section from another element, component, region, layer or section. Thus, unless otherwise defined, a first element, component, region, layer or section described below could be termed a second element, component, region, layer or section, without departing from the spirit and scope of the present disclosure.

Throughout the specification, each component may be singular or plural, unless the context clearly indicates otherwise.

The arrangement of an arbitrary component on the “upper portion (or lower portion)” or “upper (or lower) portion” of a component means that an arbitrary component is placed in contact with the upper (or lower) surface of the component. In addition, it may mean that other components may be interposed between the component and any component disposed on (or under) the component.

Also, it will be understood that when an element is referred to as being “on,” “connected to,” or “coupled to” another element, these elements can be directly connected or coupled to each other, another intervening element may be present therebetween, or the respective elements may be connected, coupled, or linked to each other through another elements.

As used herein, the term “and/or” includes any and all combinations of one or more of the associated listed items. In addition, the use of “may” when describing embodiments of the present disclosure relates to “one or more embodiments of the present disclosure.” Expressions such as “one or more” and “one or more” preceding a list of elements modify the entire list of elements but do not modify individual elements in the list.

Throughout the specification, the expression “A and/or B” means A, B, or A and B, unless otherwise defined, and the expression “C to D” means C or more and D or less, unless otherwise defined.

When the phrase “at least one of A, B, and C,” “at least one of A, B, or C,” “at least one selected from the group consisting of A, B, and C,” or “at least one selected from A, B, and C” is used to specify a list of elements A, B, and C, the phrase can refer to any and all suitable combinations.

The term “use” may be considered synonymous with the term “utilize.” As used herein, the term “substantially,” “about,” and similar terms are used as terms of approximation and not as terms of degree, and are intended to account for the inherent deviations in measured or calculated values that would be recognized by those of ordinary skill in the art.

It will be understood that, although the terms “first,” “second,” “third,” etc., may be used herein to describe various elements, components, regions, layers and/or sections, these elements, components, regions, layers and/or sections should not be limited by these terms. These terms are used to distinguish one element, component, region, layer or section from another element, component, region, layer or section. Thus, a first element, component, region, layer or section described below could be termed a second element, component, region, layer or section, without departing from the spirit and scope of the present invention.

As illustrated, spatially relative terms, such as “beneath,” “below,” “lower,” “under,” “above,” “upper,” and the like, may be used herein for ease of explanation to describe one element or feature's relationship to another element(s) or feature(s) as Illustrated in the figures. It will be understood that the spatially relative terms are intended to encompass different orientations of the device in use or in operation, in addition to the orientation depicted in the figures. For example, if the device in the figures is turned over, elements described as “below” or “beneath” or “under” other elements or features would then be oriented “above” the other elements or features. Thus, the example terms “below” and “under” can encompass both an orientation of above and below.

The terminology used herein is for the purpose of describing particular embodiments only and is not intended to be limiting of the present disclosure.

Secondary batteries can be classified into cylindrical, prismatic, and pouch types depending on the appearance thereof. Among these, a cylindrical secondary battery typically includes an electrode assembly, a can, a cap assembly, etc., and is constructed such that an electrode assembly is inserted into the can, a beading part is formed, a cap assembly is installed thereon, and a crimping part is then formed and fixed. The structure of a typical can has several problems including a relatively large number of parts, a complex manufacturing process, and so on.

Hereinafter, in exemplary embodiments of circular batteries according to embodiments of the present disclosure, one of the circular batteries is selected and the selected battery is described as having a general structure, and in the case of generally applied technology, the general structure of a circular battery is described. However, the present disclosure is not limited to this, and the case may be configured in various shapes such as a square shape or a pouch shape. In addition, the case may be made of a metal such as aluminum, an aluminum alloy, or nickel-plated steel, or a laminated film or plastic that constitutes a pouch.

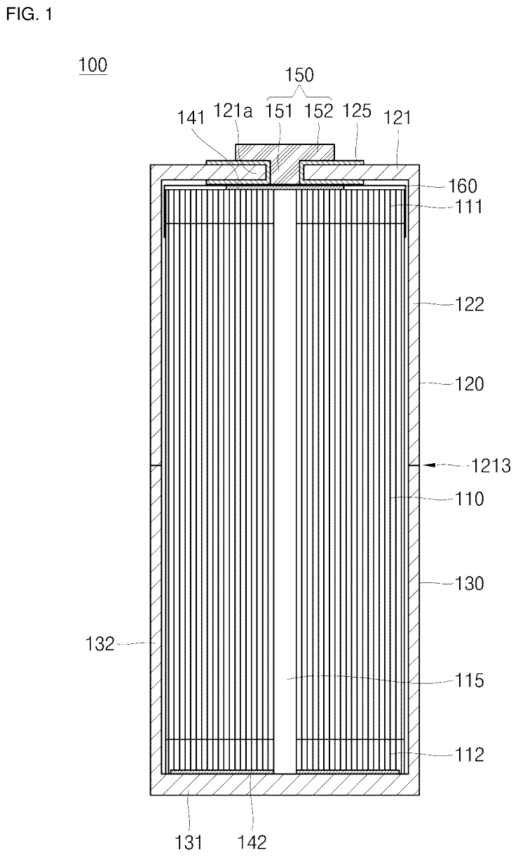

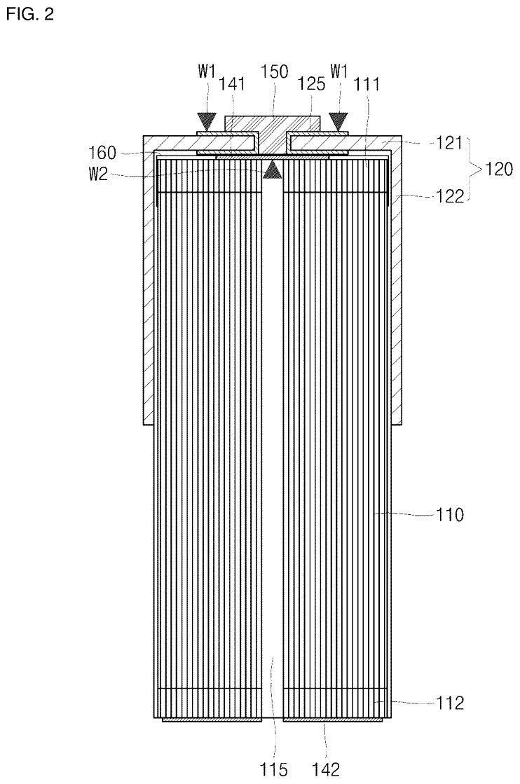

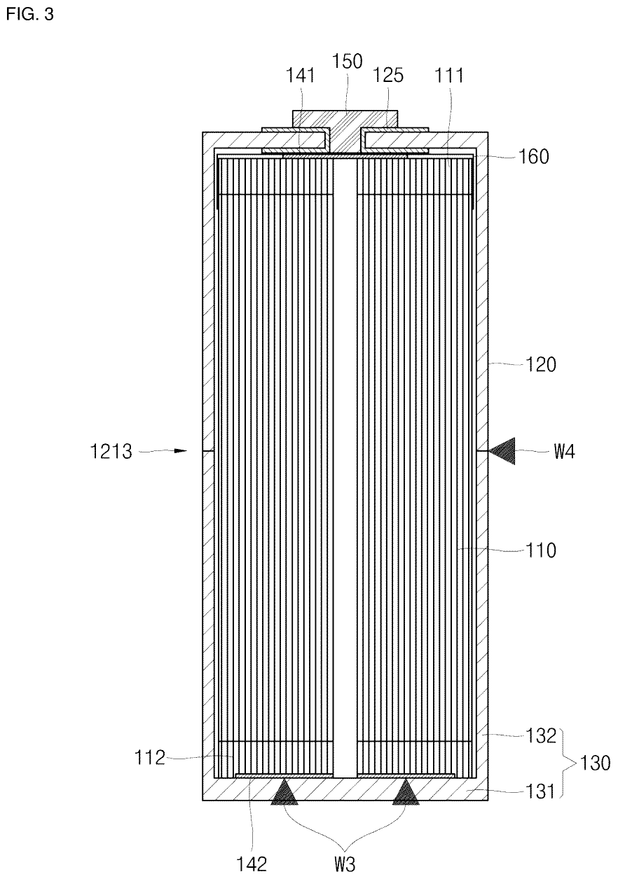

FIG. 1 is a cross-sectional view of a secondary battery 100 according to an embodiment of the present disclosure, FIG. 2 is a cross-sectional view showing a state in which an upper case 120 is assembled to an electrode assembly 110 of the secondary battery 100 according to an embodiment of the present disclosure, and FIG. 3 is a cross-sectional view showing a state in which both upper and lower cases 120 and 130 are assembled to the electrode assembly 110 of the secondary battery 100 according to an embodiment of the present disclosure. The secondary battery 100 according to an embodiment of the present disclosure may be a cylindrical secondary battery.

Referring to FIG. 1, the secondary battery 100 according to an embodiment of the present disclosure may include an electrode assembly 110 and cases 120 and 130 that accommodate the electrode assembly 110. The cases 120 and 130 may include an upper case 120 and a lower case 130 that are coupled to each other. In some examples, the upper case 120 and the lower case 130 are adjacent to each other and may include a bonded portion 1213 that bonds the same. The upper case 120 and the lower case 130 are coupled to each other to accommodate the electrode assembly 110. Hereinafter, bonding and coupling may be used in the same meaning.

The electrode assembly 110 may include a first electrode plate, a second electrode plate, and a separator.

The first electrode plate may be any one of a negative electrode plate and a positive electrode plate. For example, when the first electrode plate is a positive electrode plate, the first electrode plate may include a coated portion (e.g., a positive electrode coated portion) on which an active material (e.g., a positive electrode active material) is coated on a current collector plate (e.g., a positive electrode current collector plate) made of a thin conductive metal plate such as aluminum foil or mesh, and an uncoated portion (e.g., a positive electrode uncoated portion) 111 on which the positive electrode active material is not coated. The positive electrode active material may include a chalcogenide compound, for example, a complex metal oxide such as LiCoO₂, LiMn₂O₄, LiNiO₂, and/or LiNiMnO₂.

The second electrode plate may be the other one of the negative electrode plate and the positive electrode plate. For example, when the second electrode plate is a negative electrode plate, the second electrode plate may include a coated portion (e.g., a negative electrode coated portion) in which an active material (e.g., a negative electrode active material) is coated on a current collector plate (e.g., a negative electrode current collector plate) made of a thin conductive metal plate such as copper or nickel foil or mesh, and an uncoated portion (e.g., a negative electrode uncoated portion) 112 on which the negative electrode active material is not coated. The negative electrode active material may include, for example, a carbon-based material, Si, Sn, tin oxide, a tin alloy composite, a transition metal oxide, lithium metal nitrite, and/or a metal oxide.

The separator is interposed between the first electrode plate and the second electrode plate to prevent an electric short circuit between the first electrode plate and the second electrode plate. The separator may be made of, for example, polyethylene, polypropylene, and/or a porous copolymer of polyethylene and polypropylene.

The electrode assembly 110 is formed by stacking the first electrode plate, the separator, and the second electrode plate in that order such that the uncoated portion 111 of the first electrode plate is aligned on one side (the upper side in the drawing), and the uncoated portion 112 of the second electrode plate is aligned on the opposite side (the lower side in the drawing), and is wound to have a hollow 115 at the center.

In some examples, the upper case 120 and the lower case 130 may be coupled to each other to form a cylindrical shape. The upper case 120 may include a circular upper side portion 121 and an upper lateral side portion 122 extending a certain length downward from an edge of the upper side portion 121. The lower case 130 may include a circular lower side portion 131 and a lower lateral side portion 132 extending a certain length upward from an edge of the lower side portion 131. Each of the upper and lower cases 120 and 130 may be formed of steel, a steel alloy, aluminum, an aluminum alloy, or equivalents thereof, but the materials are not limited thereto.

The upper side portion 121 of the upper case 120 has a flat circular plate shape and may be provided with a terminal hole 121a penetrating the center. A terminal 150 may be coupled by being inserted into the terminal hole 121a of the upper side portion 121. A gasket 125 for sealing and providing electrical insulation may be further interposed between the terminal hole 121a and the terminal 150. The gasket 125 may electrically separate the terminal 150 and the upper case 120 by blocking a contact between the terminal 150 and the upper case 120. The gasket 125 may seal the terminal hole 121a of the upper side portion 121 of the upper case 120. The gasket 125 may be made of polypropylene (PP), polybutylene terephthalate (PBT), polyethylene terephthalate (PET), Perfluoroalkoxy alkane (PFA), poly tetra fluoro ethylene (PTFE), and/or a resin material such as fluororesin or phenolic resin (Bakelite).

The upper case 120 may be electrically connected to the electrode plate of the electrode assembly 110, for example, the first electrode plate, through the terminal 150. The terminal 150 may be electrically connected to the first electrode plate of the electrode assembly 110 through the first current collector plate 141. The terminal 150 may include a main body 151 arranged to extend through the terminal hole 121a of the upper side portion 121, a head 152 disposed at one end of the main body 151 and formed larger than the terminal hole 121a to be supported on the outer surface of the upper side portion 121. Here, the main body 151 may contact the first current collector plate 141 to form an electrical connection with the first current collector plate 141. Although not shown in the drawing, the other end of the main body 151 may be supported on the inner surface of the upper side portion 121 in a state of being more deformed than the terminal hole 121a.

For example, the first current collector plate 141 may be shaped to correspond to the upper surface of the electrode assembly 110, that is, a circular metal plate. A planar size of the first current collector plate 141 may be equal to or smaller than a size of the upper surface of the electrode assembly 110. The first current collector plate 141 may be made of aluminum (AI). The first current collector plate 141 may be fixed and electrically connected to the first electrode plate exposed to the upper portion of the uncoated portion 111 of the first electrode plate by welding in a state in which the lower surface thereof is in contact with the upper surface of the uncoated portion 111 of the first electrode plate. The first current collector plate 141 may be fixed and electrically connected to the terminal 150 by welding in a state in which the upper surface thereof is in contact with the lower surface of the terminal 150. The first current collector plate 141 serves as a passage for current flow between the first electrode plate of the electrode assembly 110 and the terminal 150. Here, the first current collector plate 141 may be coupled to the electrode assembly 110 from the inside of the upper case 120 through resistance welding (see W2 in FIG. 2).

The second current collector plate 142 may be shaped to correspond to the lower surface of the electrode assembly 110, that is, a circular metal plate. The second current collector plate 142 may be made of copper or a copper alloy. The second current collector plate 142 may be fixed and electrically connected to the second electrode plate exposed to the lower portion of the uncoated portion 112 of the second electrode plate by welding in a state in which the upper surface thereof is in contact with the upper surface of the uncoated portion 112 of the second electrode plate. The second current collector plate 142 may be fixed and electrically connected to the lower case 130 by welding in a state in which the lower surface thereof is in contact with the lower case 130. The second current collector plate 142 serves as a passage for current flow between the second electrode plate of the electrode assembly 110 and the lower case 130.

However, in some examples, the first current collector plate 141 may be omitted, and the upper case 120 may be coupled to the electrode assembly 110 by direct welding on the outside of the upper side portion 121 of the upper case 120 (see W1 in FIG. 2). However, since a difference in the welding uniformity may occur depending on the thickness of the upper case 120, a case-current collection structure may be applied.

In some examples, when a case-current collection structure is applied, the first current collector plate 141 may be omitted, and may be welded to the uncoated portion 111 of the first electrode plate of the electrode assembly 110 by directly contacting a welded portion (not shown) formed on the upper side portion 121 of the upper case 120. In the upper side portion 121, areas other than the welded portion may be spaced apart from the electrode assembly 110. Here, the welded portion may be welded and coupled to the electrode assembly 110 from the outside of the upper case 120. The welded portion may be formed by being concavely recessed toward the inside of the upper case 120. More specifically, the bottom surface of the welded portion may be formed to be positioned lower than the point (i.e., level or height) where the top end of the uncoated portion 111 of the first electrode plate is located when the electrode assembly 110 is accommodated in the upper case 120, for example, approximately 0.1-0.2 mm below. In other words, when the electrode assembly 110 is inserted into the upper case 120, the welded portion comes into contact with the uncoated portion 111 of the first electrode plate while slightly pressing the uncoated portion 111. Therefore, it can be ensured that the welded portion is in close contact with the uncoated portion 111 of the first electrode plate to be electrically connected. That is, when the case-current collection structure is applied, external welding can be made easier.

In addition, in some examples, the secondary battery 100 may further include an insulating member 160. Referring to FIGS. 1 to 5 and 9, the first current collector plate 141 may be disposed between the upper side portion 121 and the uncoated portion 111 of the first electrode plate. In some examples, the first current collector plate 141 may be defined as a positive electrode current collector plate that is welded and electrically connected to the first electrode plate, which is a positive electrode plate. The first current collector plate 141 may be approximately disk shaped. The first current collector plate 141 may be electrically connected to the terminal 150 at the center of the first current collector plate 141. However, since the first current collector plate 141 must be insulated from the upper case 120, the insulating member 160 may be attached to the outside of the first current collector plate 141.

In some examples, the gasket 125 may insulate between terminal 150 and upper case 120. By way of example, the gasket 125 may be composed of an upper side that insulates the outer surface of the terminal 150 and the upper side portion 121 from each other, and a lower side that insulates the inner surface of the terminal 150 and the upper side portion 121 from each other. Alternatively, the upper and lower sides of the gasket 125 may be integrally formed. The insulating member 160 may be provided between the lower side of the gasket 125 and the first current collector plate 141.

The insulating member 160 according to an embodiment of the present invention has a hollow disc shape and may be made of an insulating material. Through the hollow of the insulating member 160, the lower part of the terminal 150 and the first current collector plate 141 may be in contact with and electrically connected to each other. The remaining portions of the insulating member 160, except for the hollow, may be provided to surround the upper surface of the first current collector plate 141 and the upper outer peripheral surface of the electrode assembly 110. Therefore, the diameter of the insulating member 160 may be larger than the diameter of the electrode assembly 110. In some examples, in the insulating member 160, a surface facing the first current collector plate 141 may be formed as an adhesive surface having an insulating property. By way of example, the adhesive surface may or may not be formed in the area surrounding the upper outer peripheral surface of the electrode assembly 110. In the secondary battery according to an embodiment, after attaching the insulating member 160, the upper case 120 may be coupled to the electrode assembly 110.

FIGS. 2 and 3 show an exemplary process of sequentially assembling the upper case 120 and the lower case 130 to the electrode assembly 110 and coupling the upper case 120 and the lower case 130 to each other.

First, referring to FIG. 2, the upper portion of the electrode assembly 110 may be inserted into the upper case 120. After the electrode assembly 110 is inserted into the upper case 120, a process for fixing the upper case 120 and the electrode assembly 110, for example, welding, may be performed. Referring to FIG. 2, the coupling between the upper case 120 and the electrode assembly 110 may be achieved by welding (W1) on the outside of the upper side portion 121 of the upper case 120, and/or, welding (W2) on the inside of the upper case 120, by, for example, resistance welding, Here, the welding (W2) on the inside of the upper case 120 may be performed through the hollow 115 of the electrode assembly 110.

Referring to FIG. 3, after the electrode assembly 110 is inserted into the upper case 120 and coupled to each other through welding, etc., the lower portion of the electrode assembly 110 can be inserted into the lower case 130. After inserting the lower portion of the electrode assembly 110 into the lower case 130, the coupling between the lower case 130 and the electrode assembly 110 may be achieved by welding (W3) on the outside of the lower side portion 131 of the lower case 130. In this regard, as described above, the upper case 120 and the lower case 130 are fastened to each other to form a case that accommodates the electrode assembly 110, and a bonded portion 1213 provided between the upper lateral side portion 122 and the lower lateral side portion 132 may include at least one of welding, screw coupling, or fitting. In some examples, the upper case 120 and the lower case 130 may be coupled by at least one of welding, screw coupling, or fitting. For example, as shown in FIG. 3, the upper case 120 and the lower case 130 may be coupled by applying welding (W4) to a coupled area of the upper case 120 and the lower case 130.

In some examples, the upper case 120 and the lower case 130 may be formed to have the same lengthwise length (i.e., the vertical length in FIG. 1).

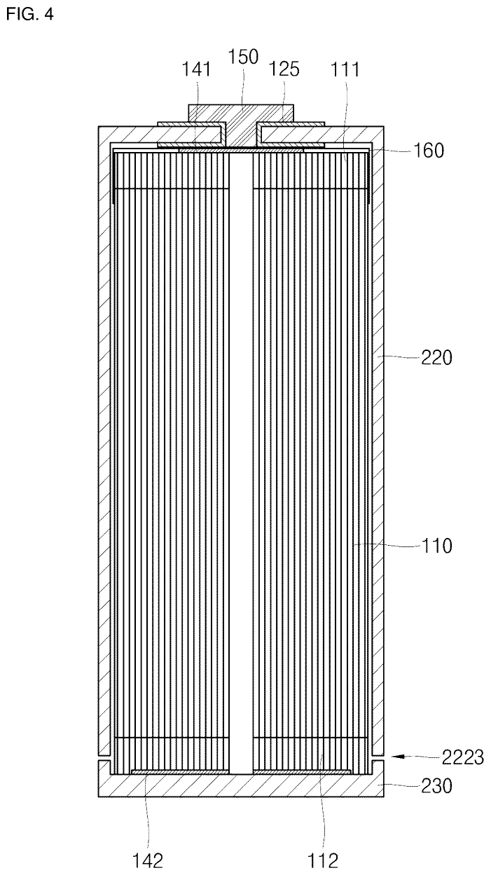

FIG. 4 is a cross-sectional view of a secondary battery according to another embodiment of the present disclosure. Referring to FIG. 4, an upper case 220 and a lower case 230 may be coupled to each other to form a case that accommodates the electrode assembly 110, and the lengthwise length of the upper case 220 may be larger than that of the lower case 230. In this case, a bonded portion 2223 of the upper and lower cases 220 and 230 is located at the bottom end of the electrode assembly 110, making welding easier by increasing the thickness of the bonded portion 2223 and further increasing the size of a bonded portion.

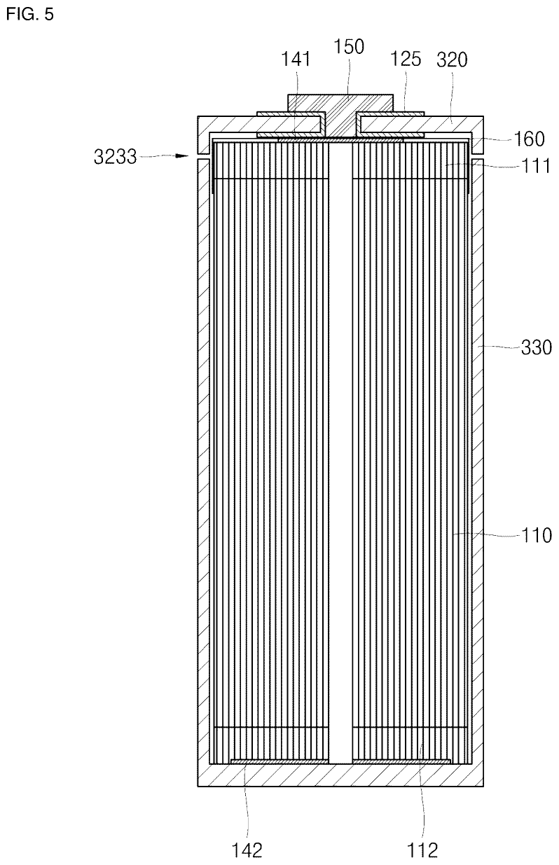

FIG. 5 is a cross-sectional view of a secondary battery according to still another embodiment of the present disclosure. Referring to FIG. 5, an upper case 320 and a lower case 330 may be coupled to each other to form a case that accommodates the electrode assembly 110, and the lengthwise length of the upper case 320 may be smaller than that of the lower case 330. In this case, a bonded portion 3233 of the upper and lower cases 320 and 330 the lower case 330 is located at the top end of the electrode assembly 110, making a coupled location positioned at the upper side portion of the entire case, thereby facilitating product management.

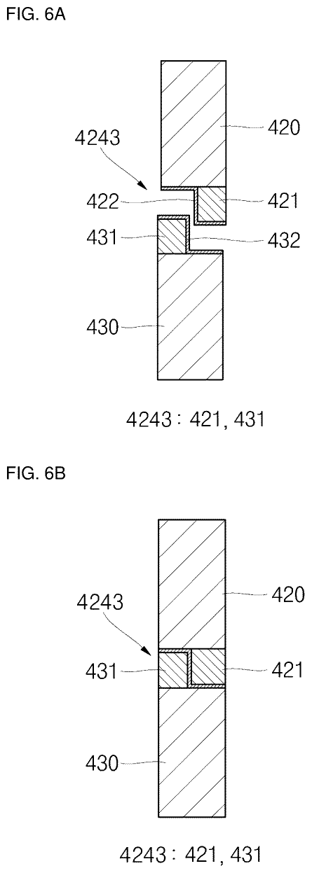

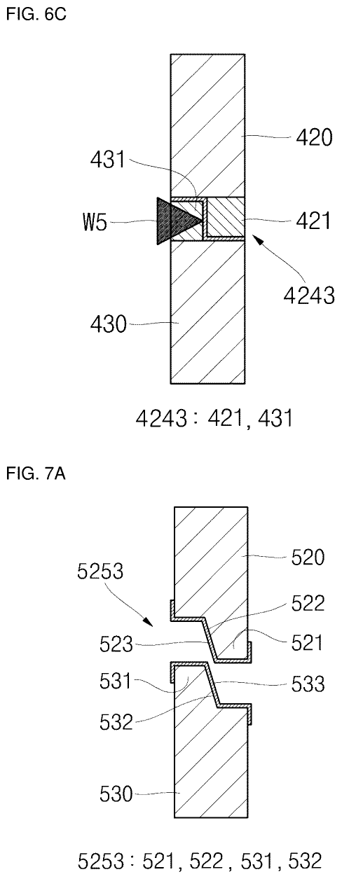

FIGS. 6 to 8 show structures of a coupled portion of an upper case 120 and a lower case 130 in secondary batteries according to various embodiments of the present disclosure. Hereinafter, several examples of bonded portions of the upper case 120 and lower case 130 will be described with reference to the drawings. Descriptions overlapping with the above-described embodiments will be omitted. The bonding structures shown in FIGS. 6 to 8 can be selectively applied to the embodiments of FIGS. 1, 4, and 5, respectively.

FIGS. 6A to 6C show the structure of a bonded portion 4243 of an upper case 420 and a lower case 430 in a secondary battery according to an embodiment of the present disclosure. Referring to FIGS. 6A to 6C, the bonded portion 4243 of the upper case 420 and the lower case 430 may include first and second protrusions 421 and 431, respectively. In some examples, coupling may be achieved in a state in which the first and second protrusions 421 and 431 are engaged with each other. Referring to FIG. 6A, the upper case 420 may include a first protrusion 421 protruding downward on a radially inner portion of the lower surface, and the lower case 430 may include a second protrusion 431 protruding upward on a radially outer portion of the upper surface. For example, the first and second protrusions 421 and 431 may have a rectangular cross-section.

In some examples, waterproof members 422 and 432, for example, coating layers, for sealing, may be formed on the surfaces of the first and second protrusions 421 and 431. For example, the coating layers may be made of a material such as Teflon and/or silicone. In some examples, coupling may be achieved after aligning the first protrusion 421 of the upper case 420 and the second protrusion 431 of the lower case 430 so as to be engaged with each other, as shown in FIG. 6B. For example, referring to FIG. 6C, welding (W5) is applied to the first and second protrusions (421, 431) that are engaged with each other to form a welding area, thereby performing coupling of the first and second protrusions 421 and 431.

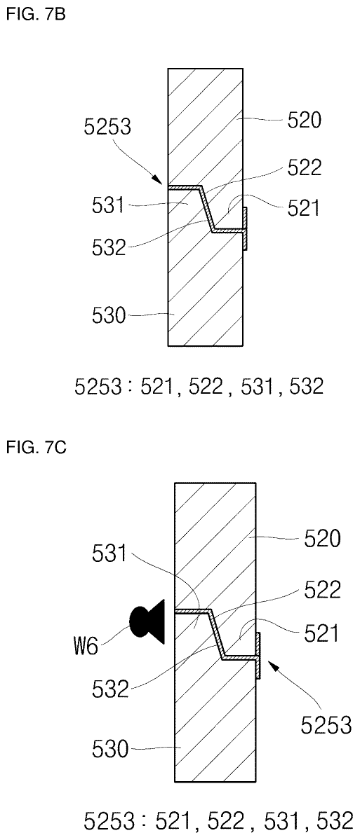

FIGS. 7A to 7C show a structure of a bonded portion 5253 of an upper case 520 and a lower case 530 in a secondary battery according to another embodiment of the present disclosure. Referring to FIG. 7A, the bonded portion 5253 of the upper case 520 and the lower case 530 includes first and second protrusions 521 and 531, respectively, and each of the first and second protrusions 521 and 531 may include inclined surfaces 522 and 532 arranged to face each other. Accordingly, the cross sections of the first and second protrusions 521 and 531 have a square shape in which one side has a diagonal line, and the first protrusion 521 of the upper case 520 and the second protrusion 531 of the lower case 530 may be arranged in a state in which diagonal lines are in contact with each other. Like in the above-described embodiments, waterproof members 523 and 533 for sealing may be formed on the surfaces of the first and second protrusions 521 and 531.

In some examples, referring to FIG. 7B, coupling may be achieved after aligning the first protrusion 521 of the upper case 520 and the second protrusion 531 of the lower case 530 so as to be engaged with each other. For example, referring to FIG. 7C, welding (W6) is applied to the first and second protrusions 521 and 531 that are engaged with each other to form a welding area, thereby performing coupling of the first and second protrusions 521 and 531. During this process, referring to FIG. 7B, when forming the waterproof members 523 and 533, a portion exposed to the outside of the bonded portion 5253 of the upper case 520 and lower case 530 may be removed by a method such as laser etching, and then bond welding may be performed.

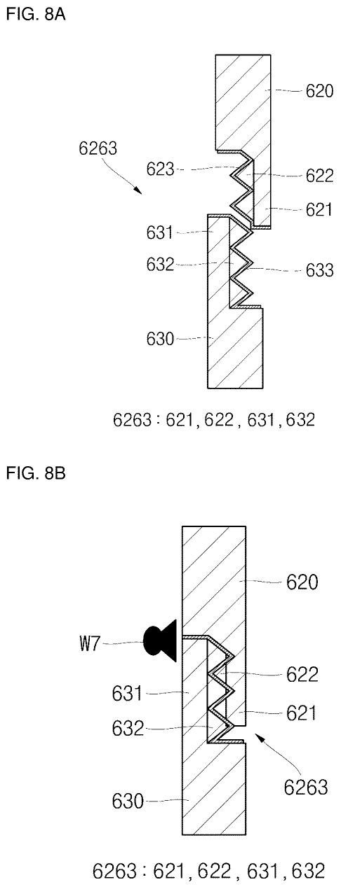

FIGS. 8A and 8B show a structure of a bonded portion 6263 of an upper case 620 and a lower case 630 in a secondary battery according to still another embodiment of the present disclosure. Referring to FIG. 8A, the bonded portion 6263 of the upper case 620 and the lower case 630 includes first and second protrusions 621 and 631, respectively, and the first and second protrusions 621 and 631 may include screw threads 622 and 632 on surfaces arranged to face each other, respectively. The upper case 620 and the lower case 630 may be coupled to each other by insertion-coupling of screw threads 622 and 623. Here, waterproof members 623 and 633 for sealing may be formed on surfaces of the screw threads 622 and 632.

In some examples, referring to FIG. 8B, the first protrusion 621 of the upper case 620 and the second protrusion 631 of the lower case 630 are able to be engaged with each other through screw coupling by the screw threads 622 and 632, and then welding (W7) is applied to the bonded portion 6263 from the outside to form a welding area, thereby performing coupling of the first and second protrusions 621 and 631.

Meanwhile, in some examples, the secondary battery 100 may include a finishing tape 200 to prevent the electrode assembly 110 from being unwound in the course of inserting the electrode assembly 110 into the cases 120 and 130 during assembling. In addition, in some examples, the secondary battery 100 may include a heating cover layer 300 formed to reduce heat generated at the back of the welding area during welding for coupling the upper case 120 and the lower case 130, which is further described herein.

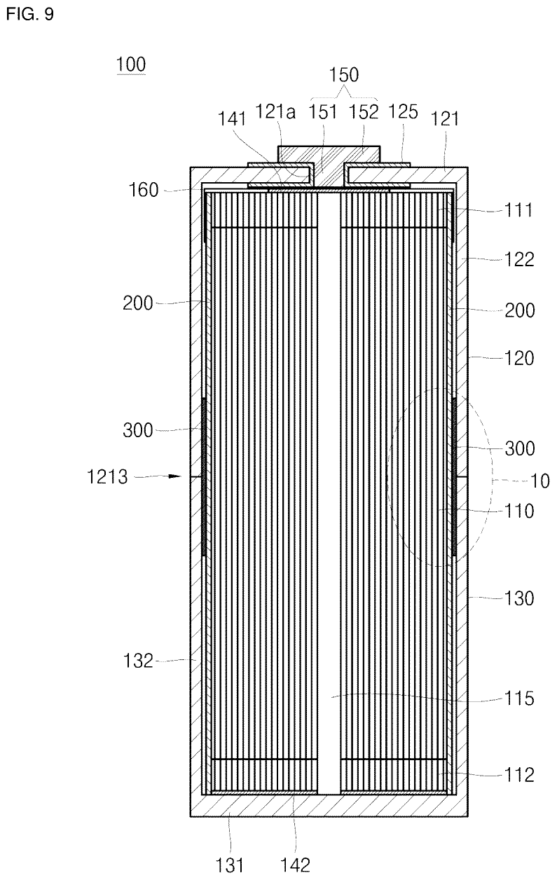

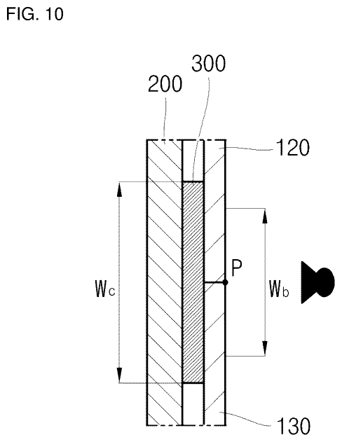

FIG. 9 is a cross-sectional view of a secondary battery according to various embodiments of the present disclosure. FIG. 10 is an enlarged cross-sectional view of a welding area shown in FIG. 9.

Referring to FIGS. 9 and 10, the finishing tape 200 at least partially surrounds the electrode assembly 110. The finishing tape 200 may include a film layer (not shown) that forms the outer surface and an adhesive layer (not shown) for attaching the film layer to the electrode assembly 110. In some examples, the finishing tape 200 may be formed to have a width corresponding to the length of the electrode assembly 110 (see FIG. 9), or may be formed to have a width smaller than the length of the electrode assembly 110. In addition, the finishing tape 200 may be provided in plural numbers and arranged to be spaced apart from each other, and may not entirely surround the electrode assembly 110 but may be attached only to a portion corresponding to a winding end. In some examples, the finishing tape 200 may be made of PP, PET, etc. That is, the continuous use temperature of the finishing tape 200 may be approximately 100 degrees (° C.) to 120 degrees (° C.).

In some examples, the heating cover layer 300 may be formed on the rear side of the welding area. In some examples, in the cases 120 and 130, the upper case 120 and the lower case 130 may be coupled to each other. For example, by applying welding (W4) to the coupled area of the upper case 120 and the lower case 130, the upper case 120 and the lower case 130 may be coupled to each other. (see FIG. 3). Here, in the welding area in the coupled location of the upper case 120 and the lower case 130, heat is generated at the rear side during welding, which may affect the electrode assembly 110.

Accordingly, in one embodiment, the heating cover layer 300 may be formed between the cases 120 and 130 and the finishing tape 200. The heating cover layer 300 may be formed by a heating cover member or coating in the form of a tape. The heating cover layer 300 may be formed along the circumference of the inner surface of the cases 120 and 130 based on the welding area.

In some examples, the heating cover layer 300 may be formed to have a width (Wc) within a certain range based on a welding contact point (P), which is a center point of the welding area. The width (Wc) of the heating cover layer 300 may refer to the vertical length based on the lengthwise direction of the electrode assembly 110 (see FIG. 9). For example, the heating cover layer 300 may be formed to have a width (Wc) within a range of 5 mm above and below based on the lengthwise direction of the electrode assembly 110 based on a welding contact point (P), which is a center point of the welding area. That is, based on the welding contact point (P), the heating cover layer 300 may be within a range of approximately 5 mm above and approximately 5 mm below based on the lengthwise direction of the electrode assembly 110. When the width (Wc) of the heating cover layer 300 exceeds the range of approximately 5 mm above and below, the thickness may be affected, and the internal capacity may also be affected. In addition, when the width (Wc) of the heating cover layer 300 exceeds the range of approximately 5 mm above and below, the unit price of the heating cover layer 300 depending on the width may rise.

In addition, in some examples, the width (Wc) of the heating cover layer 300 may correspond to the size (Wb) of a welding bead. Here, the size (Wb) of the welding bead may refer to a length of the welding bead based on the lengthwise direction of the electrode assembly 110. The welding bead may be larger than or equal to the welding area in size.

In some examples, the heating cover layer 300 may be made of polyimide (PI), Teflon, or the like. Here, when the heating cover layer 300 is made of PI, the continuous use temperature may be approximately 230 degrees (° C.), and when the heating cover layer 300 is made of Teflon, the continuous use temperature may be approximately 260 degrees (° C.). In some examples, a difference in the continuous use temperature between the finishing tape 200 and the heating cover layer 300 may be approximately 100 degrees (° C.) or more.

In some examples, with reference to FIGS. 9 and 10, although the finishing tape 200 and the heating cover layer 300 are described as being formed at a center side of the electrode assembly 110, but the lengthwise length of the upper case 220 may be larger than that of the lower case 230, and thus the coupled location of the upper and lower cases 220 and 230 may also be at the bottom end of the electrode assembly 110 (see FIG. 4). Alternatively, the lengthwise length of the upper case 320 may be shorter than that of the lower case 330, and thus the coupled location of the upper and lower cases 320 and 330 may also be at the top end of the electrode assembly 110 (e.g., see FIG. 5).

As described above, according to an embodiment of the present disclosure, by forming a case that accommodates an electrode assembly through an upper case and a lower case that are coupled to each other, the number of parts can be reduced and the process can be simplified.

However, the technical effects to be achieved in the embodiment of the disclosure are not limited to the technical problems mentioned above, and other technical effects not mentioned herein will be clearly understood from the following description by those skilled in the art to which the disclosure belongs.

Although the present disclosure has been described with reference to embodiments and drawings illustrating aspects thereof, the present disclosure is not limited thereto. Various modifications and variations can be made by a person skilled in the art to which the present disclosure belongs within the scope of the technical spirit of the present disclosure and the claims and their equivalents, below.

What is claimed is:

1. A secondary battery comprising:
an electrode assembly; and
a case accommodating the electrode assembly,
wherein the case comprises an upper case having a terminal and a lower case adjacent to the upper case, and wherein the upper case and the lower case together comprise a bonded portion for bonding the upper case and the lower case to each other.

2. The secondary battery as claimed in claim 1, wherein lengths of the upper case and the lower case are the same.

3. The secondary battery as claimed in claim 1, wherein a length of the upper case is larger than a length of the lower case.

4. The secondary battery as claimed in claim 1, wherein a length of the upper case is smaller than a length of the lower case.

5. The secondary battery as claimed in claim 1, wherein the bonded portion of the upper case and the lower case comprises protrusions, the upper case comprising at least one of the protrusions and the lower case comprising at least another of the protrusions, and the upper case and the lower case are bonded and coupled to each other by engaging the protrusions with each other.

6. The secondary battery as claimed in claim 5, wherein one or more of the protrusions of the upper case and the lower case are coated with a waterproof member.

7. The secondary battery as claimed in claim 5, wherein a welding area is formed at a portion where the protrusions of the upper case and the lower case are coupled to each other.

8. The secondary battery as claimed in claim 5, wherein a cross-section of each of the protrusions of the upper case and the lower case has a rectangular shape.

9. The secondary battery as claimed in claim 5, wherein a cross section of each of the protrusions of the upper case and the lower case has a rectangular shape and in which one side of each of the protrusions has a diagonal line, and the protrusions of the upper case and the lower case are coupled so that the diagonal lines thereof contact each other.

10. The secondary battery as claimed in claim 1, wherein the bonded portion of the upper case and the lower case comprises screw threads, the upper case and the lower case each comprising at least one of the screw threads.

11. The secondary battery as claimed in claim 10, wherein the upper case and the lower case are coupled to each other by screw coupling by the screw threads.

12. The secondary battery as claimed in claim 10, wherein at least one of the screw threads of the upper case and the lower case is coated with a waterproof member.

13. The secondary battery as claimed in claim 10, wherein the bonded portion of the upper case and the lower case includes a welding area.

14. The secondary battery as claimed in claim 1, wherein a welded portion that is welded in contact with the top end of the electrode assembly is formed on an upper side of the upper case.

15. The secondary battery as claimed in claim 14, wherein the welded portion is formed to be concavely recessed toward an inside of the upper case.

16. The secondary battery as claimed in claim 14, wherein the welded portion is welded and coupled to the electrode assembly from an outside of the upper case.

17. The secondary battery as claimed in claim 1, wherein the electrode assembly is coupled to the upper case through resistance welding.

18. The secondary battery as claimed in claim 1, wherein the lower case is coupled to the electrode assembly by welding from an outside of the lower case.

19. The secondary battery as claimed in claim 7, comprising a film layer and an adhesive layer for attaching the film layer to the electrode assembly, and further comprising a finishing tape that at least partially surrounds the electrode assembly.

20. The secondary battery as claimed in claim 19, wherein the bonded portion comprises a welding area, and the secondary battery further comprises a heating cover layer formed on a back of the welding area.

21. The secondary battery as claimed in claim 20, wherein the heating cover layer is formed between the case and the finishing tape.

22. The secondary battery as claimed in claim 21, wherein the heating cover layer has a width in a vertical direction based on a welding contact point, which is a center point of the welding area.

23. The secondary battery as claimed in claim 21, wherein the heating cover layer is formed to have a width within a range of 5 mm above a welding contact point which is at a center point of the welding contact area and 5 mm below the welding contact point, wherein the width of the heating cover layer is in a lengthwise direction of the electrode assembly.

24. The secondary battery as claimed in claim 21, wherein a width of the heating cover layer corresponds to the size of a welding bead in the welding area.

25. The secondary battery as claimed in claim 20, wherein a difference in a continuous use temperature between the finishing tape and the heating cover layer is 100 degrees (° C.) or more.

26. The secondary battery as claimed in claim 1, wherein the bonded portion of the upper case and the lower case includes at least one of a welding, a screw coupling, or a fitting.

27. The secondary battery as claimed in claim 1, wherein the upper case comprises a circular upper side portion and an upper lateral side portion extending downward from an edge of the upper side portion, the lower case comprises a circular lower side portion and a lower lateral side portion extending upward from an edge of the lower side portion, and the bonded portion is provided between the upper lateral side portion and the lower lateral side portion.
